(19) United States
(12) Patent Application Publication
(10) Pub. No.: US 2005/0259625 A1
(43) Pub. Date: Nov. 24, 2005

(54) Wireless LAN system

(75) Inventors: Hironori Hosoda, Kanagawa (JP); Yoshikazu Kobayashi, Kanagawa (JP)

Correspondence Address: YOUNG & THOMPSON, 745 SOUTH 23RD STREET, 2ND FLOOR, ARLINGTON, VA, 22202, US

(73) Assignee: NEC INFRONTIA CORPORATION, KANAGAWA (JP)

(21) Appl. No.: 10/669,367

(22) Filed: Sep. 25, 2003

(30) Foreign Application Priority Data
Nov. 26, 2002 (JP) 2002-342061

(51) Int. Cl. G06F 15/16; H04Q 7/24

(52) U.S. Cl. 370/338; 709/228

(57) ABSTRACT

The wireless LAN system 10, which permits data communication with interconnection of a PC or the like, comprises a wireless LAN driver 20 including a time zone data table part 21 with time zone data stores therein, a member country deciding part 22 for deciding a member country in each time zone, an individual presetting data table part 23 with individual country presetting data stored therein, and a device driver part 25 preset based on data from the presetting part 24. This wireless LAN system permits easy coping with a wireless specification difference in each country or geographic location when the user makes it possible to do communication by interconnecting a PC or the like via wireless LAN.

### BACKGROUND OF THE INVENTION

This application claims benefit of Japanese Patent Application No. 2002-342061 filed on Nov. 26, 2002, the contents of which are incorporated by the reference.

The present invention relates to wireless LAN (local area network) systems and, more particularly, to a wireless LAN system having an automatic time adjusting function of adopting such presetting contents as frequency channels and transmission power levels of wireless LAN stations to the specification prescribed by standard organizations in various countries.

With a recent trend of globalization of traffic and business, communication means for data communication not only locally but also globally are required. For this requirement, wired communication means such as internet systems have been proposed and broadly utilized by connecting PCs (personal computers) thereto. However, the utilization of such wired communication means is restricted to particular places, in which connection parts are prepared. Besides, such wired communication means requires considerable equipment and maintenance expenditures: On the other hand, the use of wired systems enables enlargement of the service area and reduction of equipment cost and maintenance expenditures. For this reason, wired LAN systems have been proposed.

Wired communication, however, is under superintendent management by offices which are different in different countries or regions, and is not standardized world-wide. Therefore, for interconnecting PCs or the like and wireless LAN for data communication or the like, it is necessary to have resort to a system or a mode (i.e., country mode) conforming to the wireless communication system in each country or region. Besides, with development of traffic system and globalization of business or the like, users using PCs frequently move from one country or region to other countries or regions.

For using a PC or the like in interconnection with wireless LAN, it has been necessary for the user to use what have been preset for particular country modes in individual countries or geographic locations. For using the PC or the like in other countries or regions, it has been necessary to prepare PCs fitted to these countries or regions or changing special software and substituting a module formed from part of the software, thus leading to inconvenience in use.

As relevant prior art, electronic devices typically personal computers (PC) or video recorders (VTR) usually perform various controls based on time data obtained by an internal clock function. Accordingly, automatic correcting systems have been proposed, in which correction of time differences in individual regions and updating of specified environments are performed automatically by receiving radio waves transmitted from an artificial satellite in a GPS (global positioning system) and obtaining coordinates of the measurement point (see patent literature, for instance, Japanese Patent laid open No.Hei 9-297191). Also, one or more radio and other broadcast stations may be present in each region. The frequency channels of these broadcast stations are usually different from one another. This means that it is inconvenient for the user to change the receiver presetting whenever he or she moves from one region to another by a car, in which a frequency preset type receiver is mounted. Accordingly, an automatic frequency presetting type wireless receiver has been proposed, which includes a region code detecting means for automatic presetting the receiving frequency of a frequency presetting type receiver in correspondence to the region where theuser is found (seepatent literature 2, for instance, Japanese Patent laid open No. Hei 6-125246).

As shown above, the prior art wireless LAN systems pose various problems regarding the operability for their use inapluralityof different countries or regions. Also, it is impossible from technical and cost grounds to directly apply techniques proposed with the above other electronic devices or the like.

### SUMMARY OF THE INVENTION

The present invention was made in view of the above problems inherent in the prior art, and its object is to provide a wireless LAN system capable of overcoming or alleviating these problems and suitable for use for data communication or the like with PCs or the like.

According to an aspect of the present invention, there is provided a wireless LAN-system permitting wireless communication of the user with portable communication device, wherein: the user's location is determined based on time zone data possessed by an OS (operating system) mounted on the portable communication device, and a country mode of a preset country corresponding to the user's location is determined.

A station check is made whether the preset country is employs an FH system or a DS-SS system, and the country mode is determined for each system. When a plurality of countries are present in each time zone, candidate countries are displayed on the display of the portable communication device for the user's selection of one of these candidate countries.

According to anther aspect of the present invention, there is provided a wireless LAN system permitting wireless communication of the user with portable communication device via a wireless LAN (local area network) having country mode which is different with different countries, wherein: the portable communication device includes a time zone data table with time zone data stored therein and an individual country presetting data table with individual country presetting data stored therein, and the wireless LAN system further comprises a wireless LAN driver for setting the country mode and a wireless LAN hardware module for realizing the presetting contents of the wireless LAN driver.

The wireless LAN driver includes a member country deciding part for deciding a member country based on time zone data of the time zone data table part, a presetting part for reading out and presetting the pertinent country mode of the individual country presetting data table part based on the decision result of the member country deciding part, and a device driver part for receiving an adaptive command of presetting contents transmitted from the resetting part. The time zone data are stored together with world map in the time zone data table part, and are displayed on a display of the PC or the like in response to a user's, request. The portable communication device is personal computer.

Other objects and features will be clarified from the following description with reference to attached drawings.

### BRIEF DESCRIPTION OF THE DRAWINGS

FIG. 1 is a table showing standardized organizations concerning electric communication in main countries or regions in the world;

FIG. 2 is a block diagram showing a system arrangement of a main part of a preferred embodiment of a wireless LAN system according to the present invention

FIG. 3 shows frequency hopping sets for various geographies;

FIG. 4 shows adaptable frequency channel in various countries;

FIG. 5 shows maximum output power levels in various geographic locations;

FIGS. 6 and 7 show flow charts representing an operation of the wireless LAN system according to the present invention;

FIG. 8 is a drawing for explaining time zone included in OS; and

FIG. 9 is a drawing for explaining candidate preset counties in each time zone.

### PREFERRED EMBODIMENTS OF THE INVENTION

Preferred embodiments of the present invention will now be described with reference to the drawings.

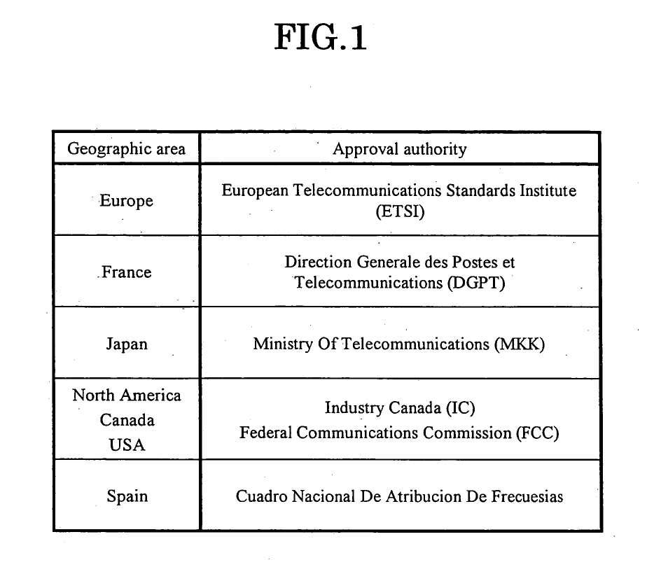

FIG. 1 is a table showing standardized organizations concerning electric communication in main countries or regions in the world. In the Figure, regions are shown in the left column, and the names of standardized organizations are shown in the right column. For example, European Telecommunication Standard Institute (ETSI) in Europe and Ministry of Telecommunications (MKK) in Japan make decision and management.

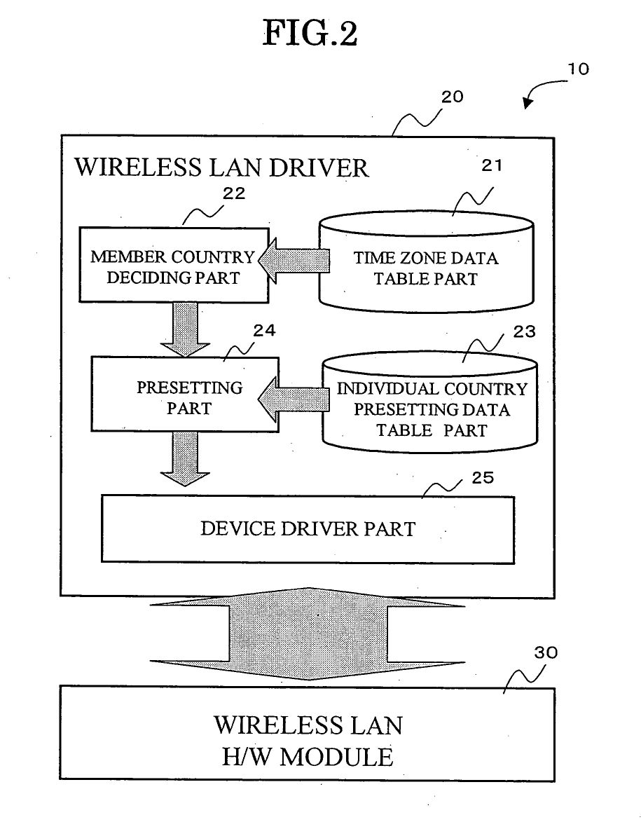

FIG. 2 is a block diagram showing a system arrangement of a main part of a preferred embodiment of a wireless LAN system according to the present invention. The wireless LAN system (or wireless LAN station) 10 includes a wireless LAN driver 20 realized in software or OS and a wireless LAN hardware (H/W) module 30. The wireless LAN driver 20 is constituted by a time zone data table part 21, a member country deciding part 22, an individual country presetting data table part 23, a presetting part 24 and a device driver 25.

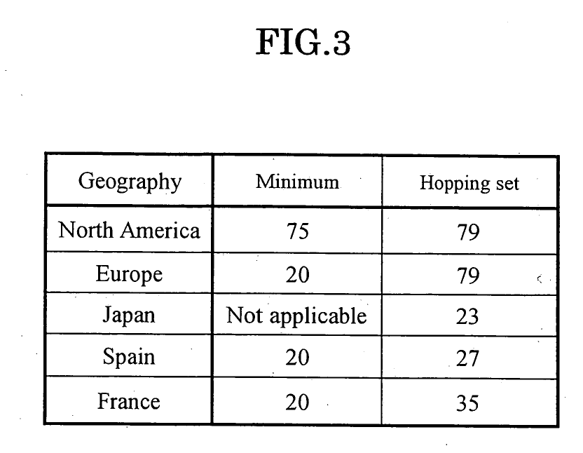

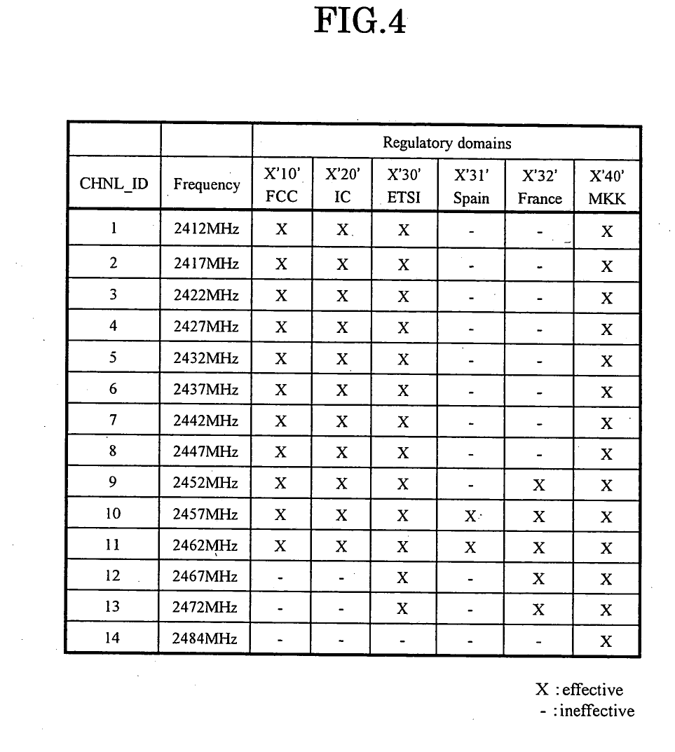

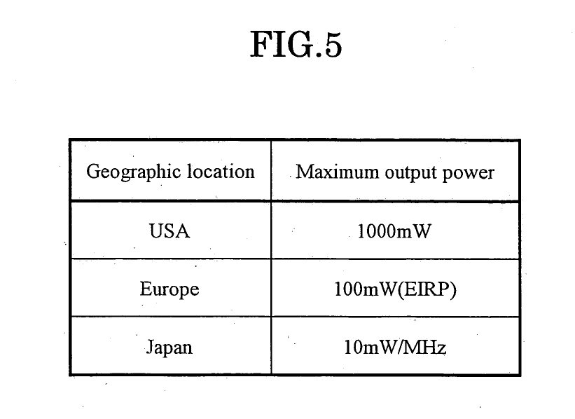

As shown in FIGS. 3 to 5, in the individual country presetting data table part 23, frequency hopping sets (FH systems) approved by standardized authorities, adaptable frequency channels (DS-SS systems) and transmission power level data. FIG. 3 shows minimums and hopping sets for various geographies. For example, the hopping set noted above is 79. FIG. 4 shows channels ID, frequencies and effectiveness (X) or ineffectiveness of regulatory domains in the standardized authorities in various countries shown in FIG. 1. Here, FCC stands for U.S.A., IC stands for Canada, ETSI stands for Europe, Spain stands for Spain, France stands for France, and MKK stands for Japan. FIG. 5 shows maximum output power levels in various geographic locations. For example, the maximum output power level is 1000 mW (i.e., 1 W) in U.S.A., and 100 mW in Europe.

When a member country is decided by the member country deciding part 22, the presetting part 24 reads out the data stored in the above individual country presetting data table part 23, and transmits an adaptive command of the presetting component to the device driverpart 25 for presetting therein. The wireless LAN module 30 is of easy design such that it can actually realize the preset content.

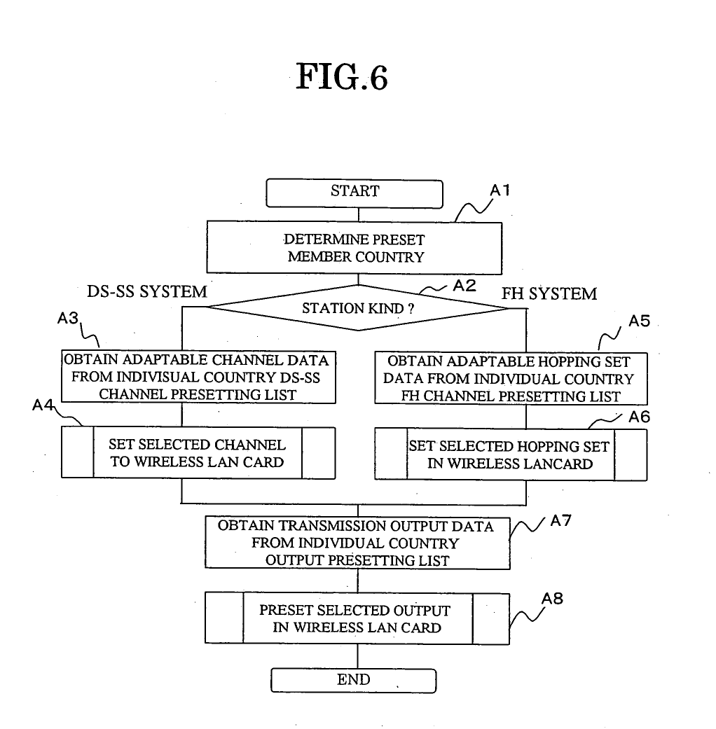

Now, an automatic presetting operation in the wireless LAN system according to the present invention will be described with reference to the flow chart shown in FIG. 6. When a country mode adjustment is requested by a user's operation, a country to be preset by the member country deciding part 22 in the wireless LAN driver 20 is first determined (step A1). Then, a station kind check, i.e., a check as to whether the station is of DS-SS system (adaptable frequency channel) or of an FH system (frequency hopping set), is made (step A2).

In the case of the DSS-SS system, the presetting part 24 obtains an adaptable channel data from an individual DS-SS channel presetting list in the individual presetting data table part 23 (step A3). The presetting part 24 transmits the content to the device driver part 25 to set the selected channel to the wireless LAN card (step A4). In the case of the FH system, the presetting part 24 obtains adaptable hopping set data from the individual country channel presetting list in the individual presetting data table part 23 (step A5). Then, the presetting part 24 presets the selected hopping set in the wireless LAN card (step A6).

After the above step A4 or A6, transmission output data is obtained from an individual country output presetting list in the individual country presetting data table part 25 (step A7). Then, the selected output is preset in the wireless LAN card (step A8), thus bringing an end to the station presetting updating operation. As the user side operation, only a “COUNTRY MODE UPDATING BUTTON” (not shown) is caused to be selected from a station utility display, and no particular input parameter is necessary.

As shown above, the property of the station is automatically updated to a presetting conforming to wireless specifications of each country, and the user thus can use wireless LAN as in the conventional way even in an oversea (or other destination) country without need of any wireless specification knowledge.

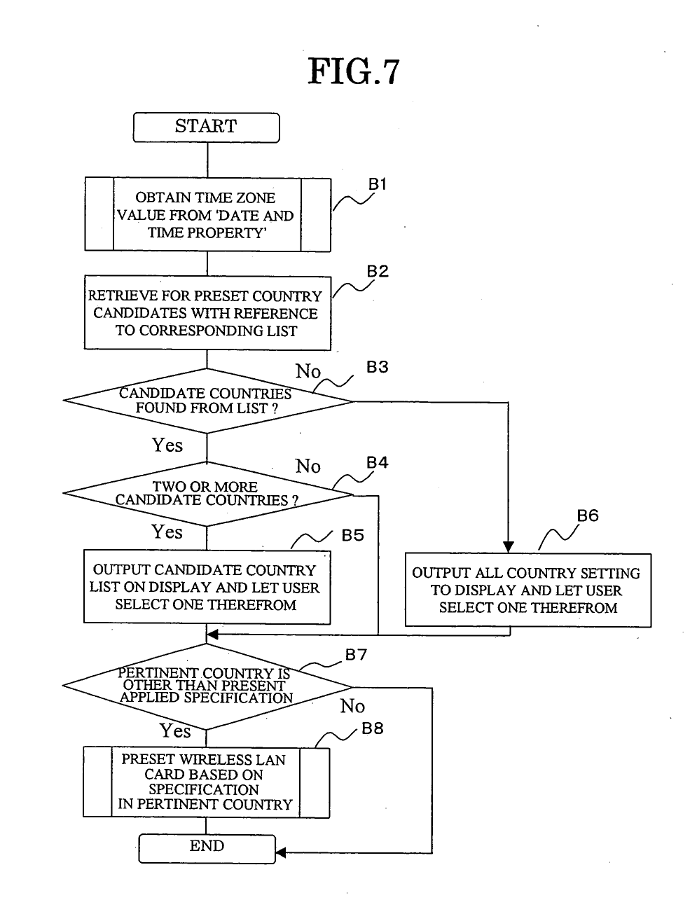

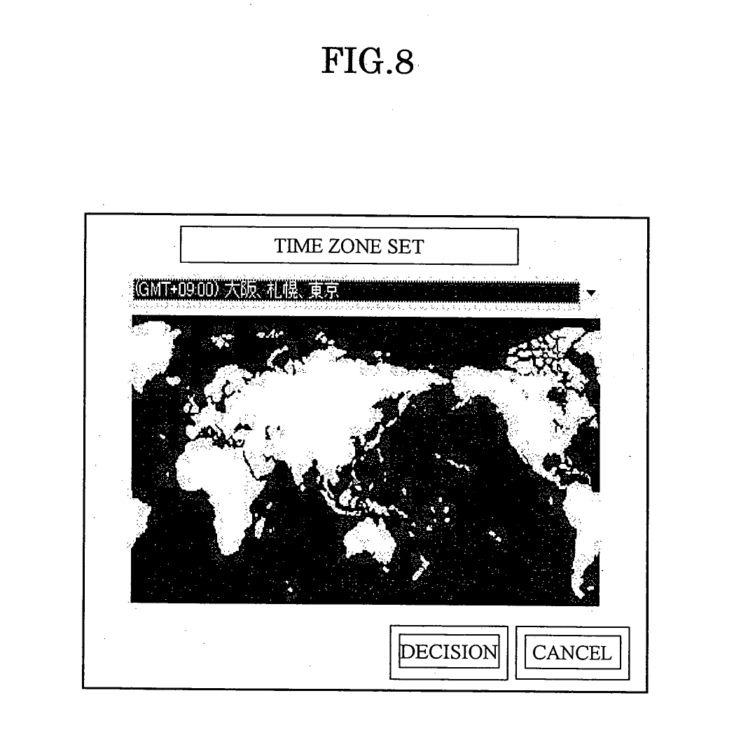

Now, an example of operation for specifying a preset country in the wireless LAN system 10 according to the present invention will be described with reference to a flow chart shown in FIG. 7. First, a station utility, to which a country mode adjustment is requested from the user, sends a time zone data possessed by an OS (operating system) as shown in FIG. 8 together with a country mode adjustment execution command to the member country deciding part 22 in the wireless LAN driver 20 and the time zone value is obtained. (step B1).

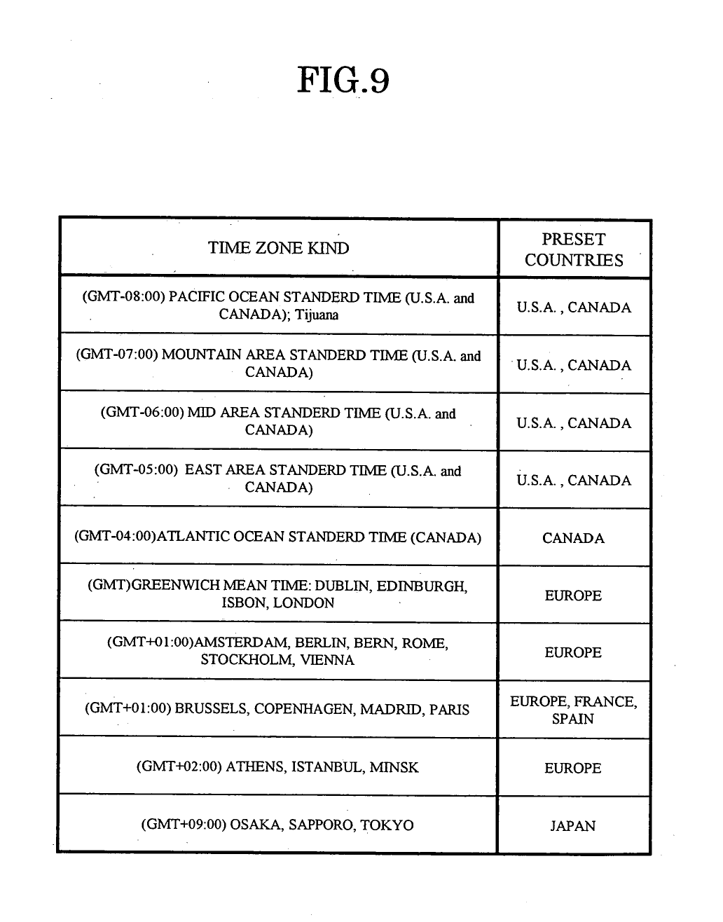

Receiving these data, the member of country deciding part 22 first retrieves for preset country candidates by using a “TIME ZONE DATA TABLE”, in which preset country candidates corresponding to the time zones as shown in FIG. 9 are stored (step B2). When a plurality of preset country candidates are retrieved, the use selects one of these candidates. When no pertinent country is detected, all the preset candidate countries are outputted on the display, and the user selects one of these countries.

Specifically, a check is made as to whether candidate countries could have been found from the list (step B3) When candidate countries could have been found (“Yes” in step B3), a check is made as to whether two or more candidate countries could have been found (step B4) . When two or more candidate countries could be found (“Yes” in step B4), the candidate country list is outputted to the display to let the user select one of these candidate countries (step B5). When no candidate country could have been found from the list (“No” in step B3), all the country settings are outputted to the display to let the user select one of these presettings (step B6) . After the above steps B5 and B6 and also when it is found in the above step B4 that the number of candidate countries is not two or more (“No” in step B4), a check is made as to whether the pertinent country is other than a country pertinent to the presently applied specification (step B7). When the country is an other country (“Yes” in step B7), presetting of wireless LAN card is made based on the specification in the pertinent country (step B8), and an end is brought to the operation. When the country is the same as of the country pertinent to the presently applied specification (“No”, in step B7), an end is brought to the operation without execution of any presetting updating.

As has been shown, with the wireless LAN system according to the present invention the country mode adjustment can be made by merely updating the OS time zone. Thus, the user can cope with even such a case bring a carried PC to foreign countries by a dispatch without need of executing any particular operation.

With the wireless LAN system according to the present invention the following practically pronounced advantages are obtainable. That is, for using a carried PC or the like, the user can make it possible, without any particular operation, to determine the user's location on the basis of time zone data possessed by an OS mounted in the PC or the like and cause automatic presetting of the wireless field specifications (i.e., country mode) pertinent to the determined country. The user thus can use the PC or the like by easily and quickly connecting the PC or the like on the basis of the specifications on the site for using the PC or the like in any place in the world.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A wireless LAN system permitting wireless communication of the user with portable communication device, wherein: the user's location is determined based on time zone data possessed by an OS (operating system) mounted on the portable communication device, and a country mode of a preset country corresponding to the user's location is determined.

2. The wireless LAN system according to claim 1, wherein a station check is made whether the preset country is employs an FH system or a DS-SS system, and the country mode is determined for each system.

3. The wireless LAN system according to claim 1, wherein when a plurality of countries are present in each time zone, candidate countries are displayed on the display of the portable communication device for the user's selection of one of these candidate countries.

4. A wireless LAN system permitting wireless communication of the user with portable communication device via a wireless LAN (local area network) having country mode which is different with different countries, wherein:
the portable communication device includes a time zone data table with time zone data stored therein and an individual country presetting data table with individual country presetting data stored therein, and the wireless LAN system further comprises a wireless LAN driver for setting the country mode and a wireless LAN hardware module for realizing the presetting contents of the wireless LAN driver.

5. The wireless LAN system according to claim 4, wherein the wireless LAN driver includes a member country deciding part for deciding a member country based on time zone data of the time zone data table part, a presetting part for reading out and presetting the pertinent country mode of the individual country presetting data table part based on the decision result of the member country deciding part, and a device driver part for receiving an adaptive command of presetting contents transmitted from the resetting part.

6. The wireless LAN system according to claim 4, wherein the time zone data are stored together with world map in the time zone data table part, and are displayed on a display of the PC or the like in response to a user's request.

7. The wireless LAN system according to claim 4, wherein the portable communication device is personal computer.

8. The wireless LAN system according to claim 1, wherein the time zone data are stored together with world map in the time zone data table part, and are displayed on a display of the PC or the like in response to a user's request.

9. The wireless LAN system according to claim 1, wherein the portable communication device is personal computer.
